(19) United States
(12) Patent Application Publication
(10) Pub. No.: US 2013/0128351 A1
(43) Pub. Date: May 23, 2013

(54) PRISM ARRAY TO MITIGATE MOIRÉ EFFECT IN AUTOSTEREOSCOPIC DISPLAYS

(71) Applicants: Jacques Gollier, Painted Post, NY (US); Vasily Dmitrievich Kuksenkov, Painted Post, NY (US)

(72) Inventors: Jacques Gollier, Painted Post, NY (US); Vasily Dmitrievich Kuksenkov, Painted Post, NY (US)

(21) Appl. No.: 13/683,543

(22) Filed: Nov. 21, 2012

Related U.S. Application Data
(60) Provisional application No. 61/563,222, filed on Nov. 23, 2011.

(51) Int. Cl. G02B 27/22

(52) U.S. Cl. CPC G02B 27/22
USPC 359/462

(57) ABSTRACT

An autostereoscopic display device includes a pixelated image source and an optical element. The pixelated image source is located along a pixel plane and includes a set of pixels and dark regions substantially filling a remainder of the pixelated image source. The pixels are arranged in a pixel array having a pixel duty factor that is defined as pixel size over pixel pitch along the pixel plane and has a value of 1/N. The optical element is located between the pixel plane and an observer plane and is configured to form a projection array of pixel projections on the observer plane. The projection array has a projection duty factor defined as pixel projection size over pixel projection pitch along the observer plane. The projection duty factor is substantially equal to 1 such that two adjacent ones of the pixel projections bound one another on the observer plane.

This application claims the benefit of priority under 35 U.S.C. §119 of U.S. Provisional Application Ser. No. 61/563222 filed on Nov. 23, 2011 the content of which is relied upon and incorporated herein by reference in its entirety.

### TECHNICAL FIELD

The present disclosure relates to autostereoscopic display devices and, more particularly, apparatus and methods for reducing visual flaws occurring in autostereoscopic display devices.

### BACKGROUND

Autostereoscopic display devices create an impression of three-dimension (3-D) without the use of special headgear or glasses by the viewer. While a variety of methods exist for enabling autostereoscopic display devices, these methods usually entail some visual flaws that are experienced by the viewer and may make it difficult for the viewer from seeing the 3-D images of satisfactory quality with clarity, for an extended period of time, from all viewing angles, etc. Thus, there is a need to improve upon the shortcomings present in the existing technology for autostereoscopic display devices.

### SUMMARY

In one example aspect, an autostereoscopic display device includes a pixelated image source and an optical element. The pixelated image source is located along a pixel plane and includes a set of pixels and dark regions substantially filling a remainder of the pixelated image source. The pixels are arranged in a pixel array having a pixel duty factor that is defined as pixel size over pixel pitch along the pixel plane and has a value of 1/N. The optical element is located between the pixel plane and an observer plane and is configured to form a projection array of pixel projections on the observer plane. The projection array has a projection duty factor defined as pixel projection size over pixel projection pitch along the observer plane. The projection duty factor is substantially equal to 1 such that two adjacent pixel projections bound one another on the observer plane.

In an example of the aspect, the optical element includes a first optical layer and a second optical layer. The first optical layer includes an integrated row of cylindrical lenses.

In yet another example of the aspect, the pixel duty factor is substantially equal to ½. The first optical layer, without the second optical layer, is configured to form a first projection array of the pixel projections, and the projection duty factor of the first projection array is substantially equal to ½.

In yet another example of the aspect, the second optical layer includes an integrated row of identical prisms.

In yet another example of the aspect, each of the prisms includes two symmetrical halves.

In yet another example of the aspect, the first optical layer and the second optical layer are configured to form, in conjunction, a second projection array in which each of the pixel projections includes a first projection component having a center and a second projection component having a center. Each of the first and second projection components is equal in length to the pixel projection size in the first projection array and the centers of which are offset from one another by a distance equal to the pixel projection size in the first projection array.

In yet another example of the aspect, each of the symmetrical halves forms a prism angle θ, which is determined by the equation θ=W/((n−1)*D). W is the pixel projection size in the first projection array, n is a refractive index of the second optical layer, and D is a viewing distance.

In yet another example of the aspect, the pixel size is substantially equal to a length of one of the cylindrical lenses along a lens plane divided by a natural number.

In yet another example of the aspect, the autostereoscopic display device further includes a third optical layer located between the pixelated image source and the observer plane. The third optical layer is in contact with the second optical layer and has a refractive index similar to that of the second optical layer.

In yet another example of the aspect, the first optical layer and the second optical layer are integrated into a single piece.

In yet another example of the aspect, the second optical layer is located nearer to the observer plane than the first optical layer.

In yet another example of the aspect, the first optical layer is located nearer to the observer plane than the second optical layer.

In yet another example of the aspect, the first optical layer is molded over the second optical layer.

In yet another example of the aspect, the dark regions are configured to be reflective.

In yet another example of the aspect, the optical element includes an integrated row of optical units. Each optical unit has symmetrical halves. Each of the symmetrical halves is shaped as a partial section of a cylindrical lens such that optical axes of the cylindrical lenses are spaced apart by a predetermined spacing dy.

In yet another example of the aspect, the predetermined spacing dy is determined by the equation dy=F*W/D. F is a focal length of the cylindrical lens in a non-sectioned state, W is a size of a pixel projection formed on the observer plane by the cylindrical lens in the non-sectioned state, and D is a viewing distance.

In another example aspect, a method of operating an autostereoscopic display device includes a pixelated image source which is located along a pixel plane and includes a set of pixels and dark regions substantially filling a remainder of the pixelated image source. The pixels are arranged in an array with a pixel duty factor defined as pixel size over pixel pitch along the pixel plane and having a value of 1/N. The method includes the steps of providing a first optical layer including a row of cylindrical lenses, the first optical layer configured to form, by itself, a projection array of pixel projections on an observer plane, the projection array having a projection duty factor that is defined as pixel projection size over pixel projection pitch along the observer plane and has a value of 1/N; and providing a second optical layer between the pixel plane and the observer plane, the second optical layer configured to adjust, in conjunction with the first optical layer, the projection duty factor so as to be substantially equal to 1.

In one example of the aspect, the second optical layer is configured to refract light.

### BRIEF DESCRIPTION OF THE DRAWINGS

These and other aspects are better understood when the following detailed description is read with reference to the accompanying drawings, in which:

FIG. 1A is a schematic top view of conventional cylindrical lenses and pixel projections formed by the conventional cylindrical lenses;

FIG. 1B is a schematic top view of an optical element, including a first optical layer and a second optical layer, and the pixel projection formed by the optical element;

FIG. 2A is a set of schematic top views showing light rays resulting from a first example embodiment of an optical unit of the first optical layer and the second optical layer in comparison with light rays from a conventional cylindrical lens;

FIG. 2B is a schematic top view of the optical unit of the second optical layer in the first example embodiment of the optical element;

FIG. 3 is a schematic top view of a second example embodiment of the optical element;

FIG. 4 is a schematic top view of an optical unit of a third example embodiment of the optical element;

FIG. 5A is a schematic view of a first embodiment of a pixelated image source; and

FIG. 5B is a schematic view of a second embodiment of the pixelated image source.

### DETAILED DESCRIPTION

Examples will now be described more fully hereinafter with reference to the accompanying drawings in which example embodiments are shown. Whenever possible, the same reference numerals are used throughout the drawings to refer to the same or like parts. However, aspects may be embodied in many different forms and should not be construed as limited to the embodiments set forth herein.

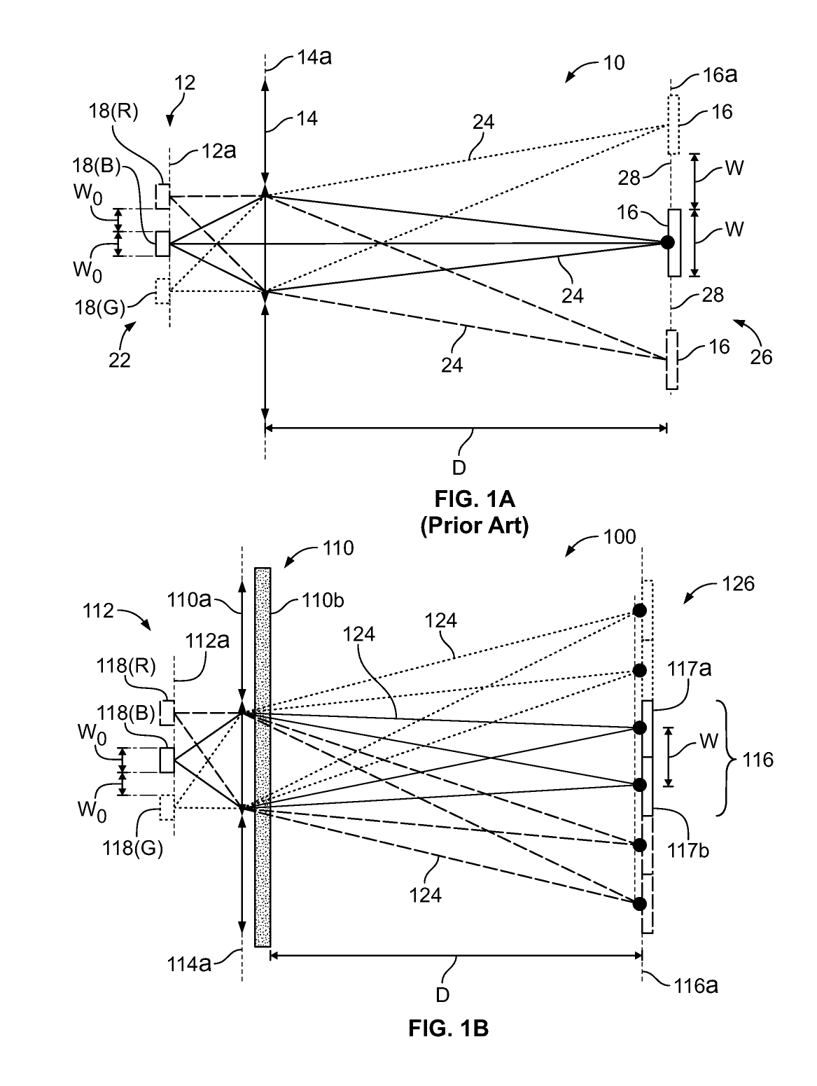

Referring now to FIG. 1A, a top view of certain components within a conventional autostereoscopic display device 10 is schematically illustrated. The conventional autostereoscopic display device 10 may include a screen such as a glass cover (not shown), a pixelated image source 12 located along a pixel plane 12a, a row of cylindrical lenses 14 indicated by arrows along an optical plane 14a, and a set of pixel projections 16 formed along an observer plane 16a at which the eyes of an observer are located and which is at a predetermined viewing distance D from the optical plane 14a. While an autostereoscopic display device 10 is configured so that an observer is likely to experience the best impression of 3-D at the viewing distance D, the impression of 3-D can still be experienced at other viewing distances.

FIGS. 5A and 5B show schematic front views of two example embodiments of the pixelated image source 12 of FIG. 1A. The pixelated image source 12 may have a background that may be rectangular in shape and may be part of a liquid crystal display (LCD), an organic light-emitting diode (OLED), etc. The pixelated image source 12 may include an array of pixels 18 having colors red R, green G and blue B with a remainder of the background forming dark regions 20, such as due to a black outer surface. While there may be other areas within the background that are not filled by either a pixel 18 or a dark region 20, part of the background other than the array of pixels 18 is substantially filled by dark regions 20. The dark region 20 may include a reflective outer surface. The ratio of the area occupied by the pixels to the area occupied by the dark regions may vary by embodiment and may be 1:1 (FIG. 5A) or 1:2 (FIG. 5B), for example. In this embodiment, the pixels 18 are rectangular in shape although this may vary in other embodiments of the pixelated image source 12.

The pixels 18 are arranged in a pixel array 22 of columns and rows similar to a matrix. The arrangement of the pixels 18 can be expressed in terms of pixel duty factor which is defined as pixel size over pixel pitch along the pixel plane. When viewed from above as shown in FIGS. 1A and 1B, pixel size is the length by which a pixel 18 extends along the pixel plane 12a while pixel pitch is the distance between the centers of two adjacent pixels 18 along the pixel plane 12a. Thus, the pixel duty factor in FIG. 5A is ½ because the pixel size is Wo and the pixel pitch is 2Wo while the duty factor in FIG. 5B is ⅓ because the pixel size is Wo and the pixel pitch is 3Wo. Accordingly, one way to express the pixel duty factor is 1/N where N can be a positive number or a natural number.

In FIG. 1A, the cylindrical lenses 14 are located at a distance from the pixelated image source 12 and a pixel projection 16 is formed on the observer plane 16a which is at a predetermined distance D from the cylindrical lenses 14. Light rays 24 originating from adjacent pixels 18 pass through a given cylindrical lens 14 and form adjacent pixel projections 16 on the observer plane 16a. Similarly to the pixels 18 of the pixelated image source 12, the arrangement of the pixel projections 16 on the observer plane 16a can also be expressed in terms of projection duty factor which is defined as pixel projection size over pixel projection pitch. In case of the pixelated image source 12 in FIG. 1A, the pixel projections 16 created by a conventional cylindrical lens 14 form a first projection array 26 of pixel projections 16 with a projection duty factor of ½ such that the centers of two adjacent pixel projections 16 each having length W along the observer plane 16a are separated by 2W.

In the first projection array 26 of FIG. 1A, depending on the location of a viewer and the size of the pixel projection W, it is possible for the eyes of the viewer to be located in the gaps 28 which are formed between the pixel projections 16 and at which the viewer will experience a darkening of the screen. The present disclosure describes a number of ways by which the darkening effect experienced by the viewer can be reduced.

FIG. 1B shows an example embodiment of an autosterescopic display device 100 for avoiding the darkening effect described above. The configuration is similar to FIG. 1A with a pixelated image source 112, pixels 118 on pixel plane 112a and pixel projections 116 on observer plane 116a except that an optical element 110 is used instead of the conventional cylindrical lenses 14. The optical element 110 may extend along an optical plane 114a between the pixel plane 112a and the observer plane 116a and may include a first optical layer 110a and a second optical layer 110b which will be described in more detail below. The first optical layer 110a is primarily responsible for creating the 3-D impression and may be an integrated row of cylindrical lenses 114 although other configurations (e.g., parallel barrier, volumetric, electro-holographic, light-field displays) can also be contemplated. The light rays 124 passing through the first optical layer 110a and the second optical layer 110b are bent such that a second projection array 126 of pixel projections 116 is formed on the observer plane 116a. Instead of the original pixel projections 16 which would have been formed solely by the cylindrical lenses 14, each pixel projection 116 includes two projection components 117 (i.e., a first projection component 117a and a second projection component 117b) with length W along the observer plane 116a. Moreover, the first projection component 117a and the second projection component 117b become offset from the center of the original pixel projection 16 by a distance of W/2 in opposite directions along the observer plane 116a. Since this also occurs for light rays 124 that originate from adjacent pixels 118 and go through the same combination of the first optical layer 110a and the second optical layer 110b, the gaps 28 that were present between the pixel projections 16 in the configuration of FIG. 1A are substantially filled by projection components 117 and adjacent pixel projections 116 peripherally bound one another along the observer plane 116a.

In the second projection array 126 of FIG. 1B, the projection duty factor is 1 or substantially equal to 1 because the pixel projection size is 2W (i.e., the sum of the lengths of the first projection component 117a and the second projection component 117b along the observer plane 116a) and the pixel projection pitch is also 2W (because the center of each pixel projection 116 is located at the boundary of the first projection component 117a and the second projection component 117b).

It must be noted that, while a projection duty factor of 1 was obtained for a pixel array 22 having a pixel duty factor ½ in FIG. 1B, it is also possible to obtain a projection duty factor of 1 for pixel arrays 22 having a pixel duty factor of 1/N (e.g., ⅓ in FIG. 5B) by appropriate configuration of the optical element 110 or the second optical layer 110b for example.

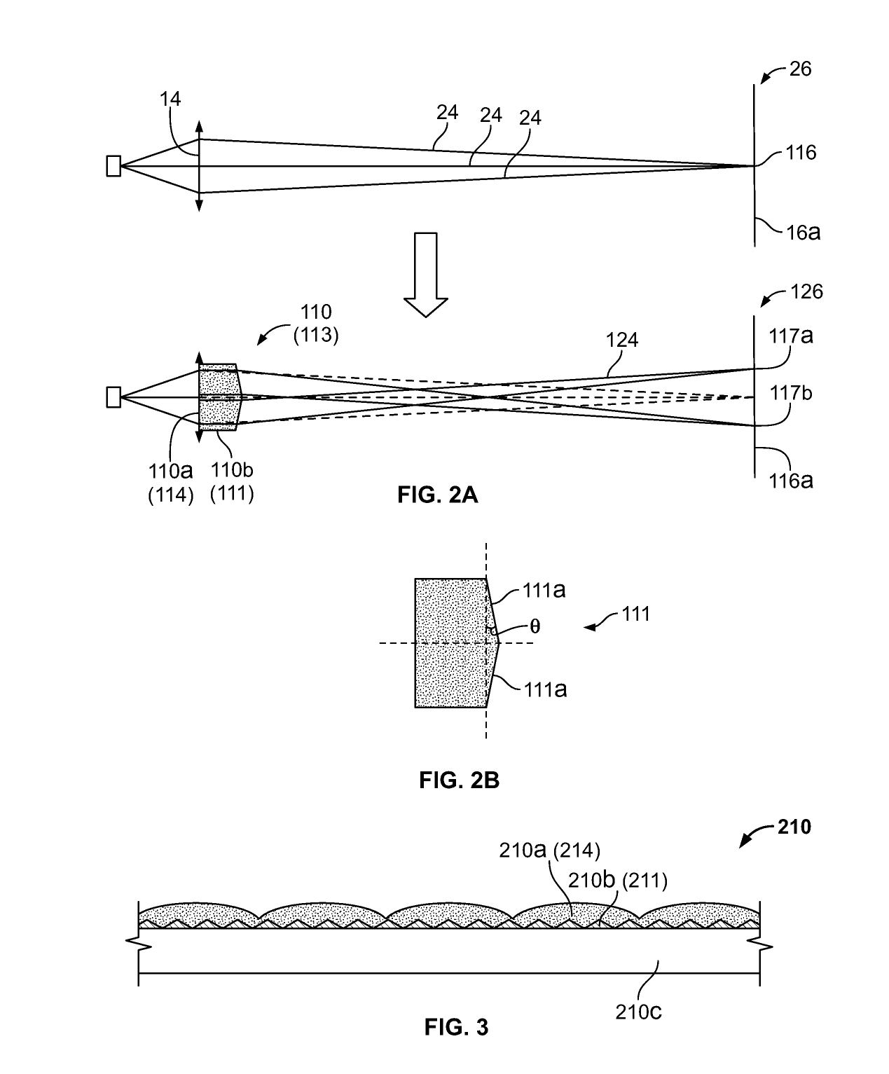

The second optical layer 110b of FIG. 1B can be an integrated row of a prism 111. FIG. 2A illustrates the effect on the light rays from a pixel by an example embodiment of the optical unit 113 for the second optical layer 110b. This optical unit 113, a top view of which is shown in FIG. 2B, may be a cylindrical structure with the illustrated pentagonal cross-section such that the prism 111 includes two symmetrical halves 111a. The cross-section is shaped such that a prism angle (FIG. 2B) is equal to θ=W/((n−1)*D) where W is the pixel projection size in the first projection array 26, n is the refractive index of the second optical layer and D is a viewing distance which is measured from the optical plane 114a to the observer plane 116a. It should be noted that D can be measured from any plane in proximity with the first optical layer 110a, the second optical layer 110b because the distance between the optical plane 114a and a plane in close proximity with the optical plane 114a is generally negligible compared to the value of D.

In case the optical element includes at least two distinct optical layers, various arrangements of the optical layers are possible as shown in FIG. 3. While the second optical layer 110b is located nearer to the observer plane 116a in the embodiment of FIG. 1B, it is possible to embody an optical element 210 in which the first optical layer 210a (e.g., the cylindrical lenses 214) is nearer to the observer plane 116a than the second optical layer 210b (e.g., the prism 211). Moreover, while the second optical layer 210b may simply be surrounded by ambient air, it is also possible to arrange the second optical layer 210b or the prism 211 to be in contact with a third optical layer 210c, as shown in FIG. 3. The third optical layer 210c may be made of epoxy and/or material having a refraction index close to that of the prism 211. The use of material having such a refraction index also helps control phenomena such as reflection of ambient light or scattering of light caused by roughness of the surface of the prism 211. In the optical element of FIG. 3, the three optical layers 210a, 210b, 210c are arranged on top of one another and such a configuration may be accomplished by way of overmolding, for example. Of course, it may be necessary to reconfigure the prism angle θ in case of use of additional optical layers in order to obtain the desired arrangement of the projection components 117 on the observer plane 116a.

In the embodiments with cylindrical lenses 114 as the first optical layer 110a and prisms 111 as the second optical layer 110b, the cylindrical lens 114 may be dimensioned such that the ratio of the length of the cylindrical lens 114 to the length of the prism 111 along the optical plane 114a approximates a natural number. In FIG. 3, for example, this ratio is about 4. It is possible to obtain an entirely homogeneous power distribution between the first projection component 117a and the second projection component 117b if this ratio is equal to a natural number. If the ratio is not equal to a natural number, the maximum deviation in power is equal to 1 over twice the number of full optical units 113. For example, if there are 10.5 prisms per cylindrical lens, the maximum power deviation is 1 over 20 since there is 1 non-paired facet of a prism and 20 paired facets of 10 prisms. Moreover, it can be shown that the prisms 111 do not need to be accurately aligned with respect to the lenticular lens as a small tilt will not greatly change the angles of separation and a phase difference will not change the maximum power deviation. The term “lenticular lens” is intended to mean a row of cylindrical lenses having a convex cross-section.

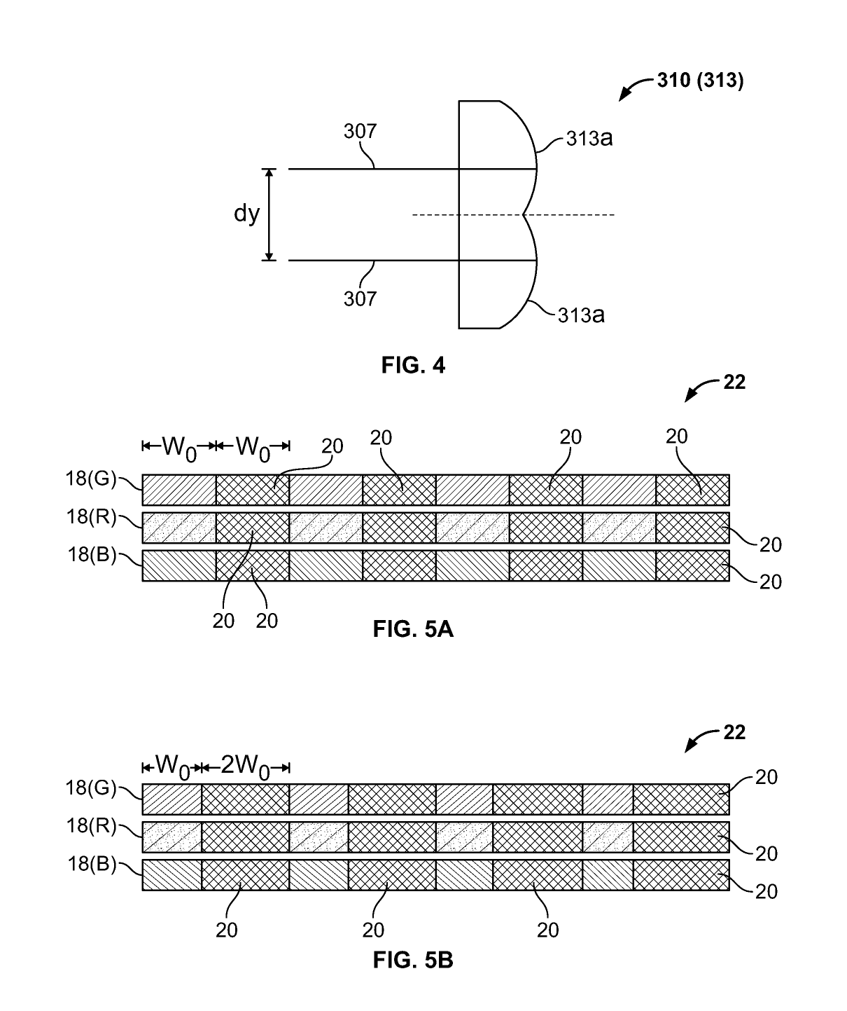

Another example embodiment of the optical element 310 may be formed through an integrated row of optical units 313 shown in FIG. 4 isolated from other adjacent optical units 313. The optical unit 313 of FIG. 4 includes two symmetrical halves 313a each of which is a partial section of an entire cylindrical lens which is shaped as if the cylindrical lens was cut across a plane that is parallel to the optical axis 307 of the lens and that extends along the cylinder. The optical axes 307 of these halves 313a are spaced apart by a spacing dy which is determined by the equation dy=F*W/D where F is the focal length of an entire cylindrical lens, W is the length of the pixel projection formed on the observer plane by an entire cylindrical lens (i.e., the size of a pixel projection 16 in the first projection array 26), and D is the viewing distance from the optical plane 114a to the observer plane 116a.

The optical element of FIG. 4 combines the functions of the cylindrical lens 114 and the prism 111 of the optical unit 113 in FIG. 2A into an optical unit 313 having a single optical layer made of one type of material.

It will be apparent to those skilled in the art that various modifications and variations can be made without departing from the spirit and scope of the claimed invention.

What is claimed is:

1. An autostereoscopic display device including:
a pixelated image source located along a pixel plane and including a set of pixels and dark regions substantially filling a remainder of the pixelated image source, the pixels arranged in a pixel array having a pixel duty factor that is defined as pixel size over pixel pitch along the pixel plane and has a value of 1/N; and
an optical element located between the pixel plane and an observer plane, the optical element configured to form a projection array of pixel projections on the observer plane, the projection array having a projection duty factor defined as pixel projection size over pixel projection pitch along the observer plane, wherein the projection duty factor is substantially equal to 1 such that two adjacent pixel projections bound one another on the observer plane.

2. The autostereoscopic display device of claim 1, wherein the optical element includes a first optical layer and a second optical layer, the first optical layer including an integrated row of cylindrical lenses.

3. The autostereoscopic display device of claim 2, wherein the pixel duty factor is substantially equal to ½, the first optical layer, without the second optical layer, is configured to form a first projection array of the pixel projections, and the projection duty factor of the first projection array is substantially equal to ½.

4. The autostereoscopic display device of claim 3, wherein the second optical layer includes an integrated row of identical prisms.

5. The autostereoscopic display device of claim 4, wherein each of the prisms includes two symmetrical halves.

6. The autostereoscopic display device of claim 5, wherein the first optical layer and the second optical layer are configured to form, in conjunction, a second projection array in which each of the pixel projections includes a first projection component having a center and a second projection component having a center, wherein each of the first and second projection components is equal in length to the pixel projection size in the first projection array and the centers of which are offset from one another by a distance equal to the pixel projection size in the first projection array.

7. The autostereoscopic display device of claim 6, wherein each of the symmetrical halves forms a prism angle θ, which is determined by the equation θ=W/((n−1)*D), wherein W is the pixel projection size in the first projection array, n is a refractive index of the second optical layer, and D is a viewing distance.

8. The autostereoscopic display device of claim 2, wherein the pixel size is substantially equal to a length of one of the cylindrical lenses along a lens plane divided by a natural number.

9. The autostereoscopic display device of claim 2, further including a third optical layer located between the pixelated image source and the observer plane, the third optical layer being in contact with the second optical layer and having a refractive index similar to that of the second optical layer.

10. The autostereoscopic display device of claim 2, wherein the first optical layer and the second optical layer are integrated into a single piece.

11. The autostereoscopic display device of claim 2, wherein the second optical layer is located nearer to the observer plane than the first optical layer.

12. The autostereoscopic display device of claim 2, wherein the first optical layer is located nearer to the observer plane than the second optical layer.

13. The autostereoscopic display device of claim 2, wherein the first optical layer is molded over the second optical layer.

14. The autostereoscopic display device of claim 1, wherein the dark regions are configured to be reflective.

15. The autostereoscopic display device of claim 1, wherein the optical element includes an integrated row of optical units, each optical unit having symmetrical halves, each of the symmetrical halves shaped as a partial section of a cylindrical lens such that optical axes of the cylindrical lenses are spaced apart by a predetermined spacing dy.

16. The autostereoscopic display device of claim 15, wherein the predetermined spacing dy is determined by the equation dy=F*W/D, wherein F is a focal length of the cylindrical lens in a non-sectioned state, W is a size of a pixel projection formed on the observer plane by the cylindrical lens in the non-sectioned state, and D is a viewing distance.

17. A method of operating an autostereoscopic display device including a pixelated image source which is located along a pixel plane and includes a set of pixels and dark regions substantially filling a remainder of the pixelated image source, the pixels arranged in an array with a pixel duty factor defined as pixel size over pixel pitch along the pixel plane and having a value of 1/N, the method including the steps of:
providing a first optical layer including a row of cylindrical lenses, the first optical layer configured to form, by itself, a projection array of pixel projections on an observer plane, the projection array having a projection duty factor that is defined as pixel projection size over pixel projection pitch along the observer plane and has a value of 1/N; and
providing a second optical layer between the pixel plane and the observer plane, the second optical layer configured to adjust, in conjunction with the first optical layer, the projection duty factor so as to be substantially equal to 1.

18. The method of claim 17, wherein the second optical layer is configured to refract light.
